(19) United States
(12) Patent Application Publication
(10) Pub. No.: US 2014/0006742 A1
(43) Pub. Date: Jan. 2, 2014

(54) STORAGE DEVICE AND WRITE COMPLETION NOTIFICATION METHOD

(71) Applicant: FUJITSU LIMITED, Kawasaki-shi (JP)

(72) Inventor: Yoshiyuki Tokumitsu, Kahoku (JP)

(73) Assignee: FUJITSU LIMITED, Kawasaki-shi (JP)

(21) Appl. No.: 13/926,434

(22) Filed: Jun. 25, 2013

(30) Foreign Application Priority Data
Jun. 29, 2012 (JP) 2012-147930

(51) Int. Cl. G06F 12/02

(52) U.S. Cl. CPC G06F 12/02
USPC 711/165

(57) ABSTRACT

A storage device includes a first control device having a memory controller that controls data write, a first determination unit that determines a state of a queue managed by the memory controller, and a first notification unit that outputs a state notification indicating that the queue is in a certain state, and a second control device having a second determination unit that determines whether or not the state notification output from the first control device has already been received, an evacuation unit that evacuates data on the write command to another control device, and a second notification unit that outputs to the high-level device a completion notification indicating that writing the data is complete, after the evacuation unit finishes evacuating the data on the write command.

### CROSS-REFERENCE TO RELATED APPLICATION(S)

This application is based upon and claims the benefit of priority of the prior Japanese Patent Application No. 2012-147930, filed on Jun. 29, 2012, the entire contents of which are incorporated herein by reference.

### FIELD

The embodiments discussed herein are related to a storage device and the like.

### BACKGROUND

In recent years, there has been a growing demand for making input/output highly efficient, and a high speed input/output interface such as a PCI Express interface (hereinafter also referred to as “PCIe”) has been used. In a storage device, a switch having a PCIe specification is provided inside a controller module (hereinafter referred to as a “CM”) that controls a storage medium such as a disk. The storage device equipped with a PCIe switch, according to the related art, is described referring to FIG. 6.

FIG. 6 is a diagram illustrating an example of a hardware configuration of the storage device according to the related art. As illustrated in FIG. 6, in a storage device 900, a CM #0 and a CM #1 are made redundant, a CM #2 and a CM #3 are made redundant, and the CMs #0 to #3 are connected to each other with the PCIe switch. The CM #3 is connected to a host. Each of the CMs #0 to #3 has a CPU 910, dual inline memory modules (DIMMs) 920, and a memory controller 930. Furthermore, each of the CMs #0 to #3 has channel adapters (CAs) 940, disk interfaces (DIs) 950, direct memory access (DMA) controllers 960, and a PCIe switch 970. The DIMM 920 is a memory module. The memory controller 930 is a controller which controls the DIMMs 920. The CA 940 is an interface with a host. The DI 950 is an interface to a disk. The DMA controller 960 is a controller in DMA between the CMs. DMA refers to a data transfer method of transmitting data directly between the DIMMs 920 and another CM without involving the CPU 910. Write of the data to the DIMM 920 by DMA is referred to as “DMA write.”

The PCIe switch 970 is connected to the memory controller 930, the CAs 940, the DIs 950, and the DMA controllers 960 as input/output devices. The PCIe switch 970 has a queue inside for every input/output device, and sequentially processes packets accumulated in the queue. The memory controller 930 has also a queue 931 in which the packets output from the PCIe switch 970 are accumulated, and the PCIe switch 970 determines whether the queue 931 is full, using the number of credits remaining for the queue.

A flow of processing in a case where a write command to write data to a disk space managed by the CM #0 and CM #1 is issued from the host is described as follows. First, the host outputs the write command to the CA 940 of the CM #3 connected to the host. Next, the CA 940 of the CM #3 performs a DMA write to the DIMM 920. The DMA controller 960 of the CM #3 performs the DMA write to a memory space of the CM #0 and the CM #1.

Subsequently, in the CM #0 and the CM #1, the DMA controller 960 tries the DMA write to the DIMM 920 via the PCIe switch 970. At this time, when the number of credits remaining in the queue 931 of the memory controller 930 is not zero, the PCIe switch 970 transmits a DMA write command packet without delay to the memory controller 930. The memory controller 930 performs the write to the memory space according to a DMA write command indicated by the received packet.

In the CM #0 and the CM #1, the DMA controller 960 performs a DMA write completion interruption on the CPU 910, and the CPU 910 notifies the CA 940 of the CM #3 of a DMA write completion. In the CM #3, the CA 940 notifies the host of the write completion. Moreover, when the number of the remaining credits is zero in the queue 931, the PCIe switch 970 waits until there is free credit, without transmitting the DMA write command packet to the memory controller 930.

Japanese Laid-open Patent Publication No. 2008-9980 is an example of the related art.

However, in a case where the write command from the host is concentrated at the same CM, there is a problem in that the write performance of the host decreases. That is, when the number of the remaining credits is zero, the PCIe switch of the CM, at which the write command is concentrated, waits until there is free credit without transmitting the DMA write command packet to the memory controller. As a result, the host is unable to receive the write command completion, until there is free credit and then the DMA write is complete. Therefore, the write performance of the host decreases.

According to one aspect, an object of the present disclosure is to suppress a decrease in write performance of a host even though the write commands are concentrated at the same CM.

### SUMMARY

According to an aspect of the embodiments, a storage device includes a first control device having a memory controller that controls data write, a first determination unit that determines a state of a queue managed by the memory controller and a first notification unit that outputs a state notification indicating that the queue is in a certain state, in a case where the first determination unit determines that the queue inside the memory controller is in the certain state, and a second control device having a second determination unit that determines whether or not the state notification output from the first control device has already been received, in a case where a write command that writes data to a storage medium managed by the first control device is received from a high-level device, an evacuation unit that evacuates data on the write command to another control device, in a case where the second determination unit determines that the state notification output from the first control device has already been received, and a second notification unit that outputs to the high-level device a completion notification indicating that writing the data is complete, after the evacuation unit finishes evacuating the data on the write command.

The object and advantages of the invention will be realized and attained by means of the elements and combinations particularly pointed out in the claims.

It should be understood that both the foregoing general description and the following detailed description are exemplary and explanatory and are not restrictive of the invention, as claimed.

### BRIEF DESCRIPTION OF DRAWINGS

FIG. 1 is a diagram illustrating a hardware configuration of a storage device according to a first embodiment.

FIG. 2 is a diagram illustrating a sequence between CMs of the storage device according to the first embodiment.

FIG. 3 is a diagram illustrating a hardware configuration of a storage device according to a second embodiment.

FIG. 4 is a diagram illustrating a hardware configuration of a storage device according to a third embodiment.

FIGS. 5A is a diagram (1) illustrating a sequence between CMs of the storage device according to the third embodiment.

FIGS. 5B is a diagram (2) illustrating the sequence between the CMs of the storage device according to the third embodiment.

FIGS. 5C is a diagram (3) illustrating the sequence between the CMs of the storage device according to the third embodiment.

FIG. 6 is a diagram illustrating a hardware configuration of a storage device according to the related art.

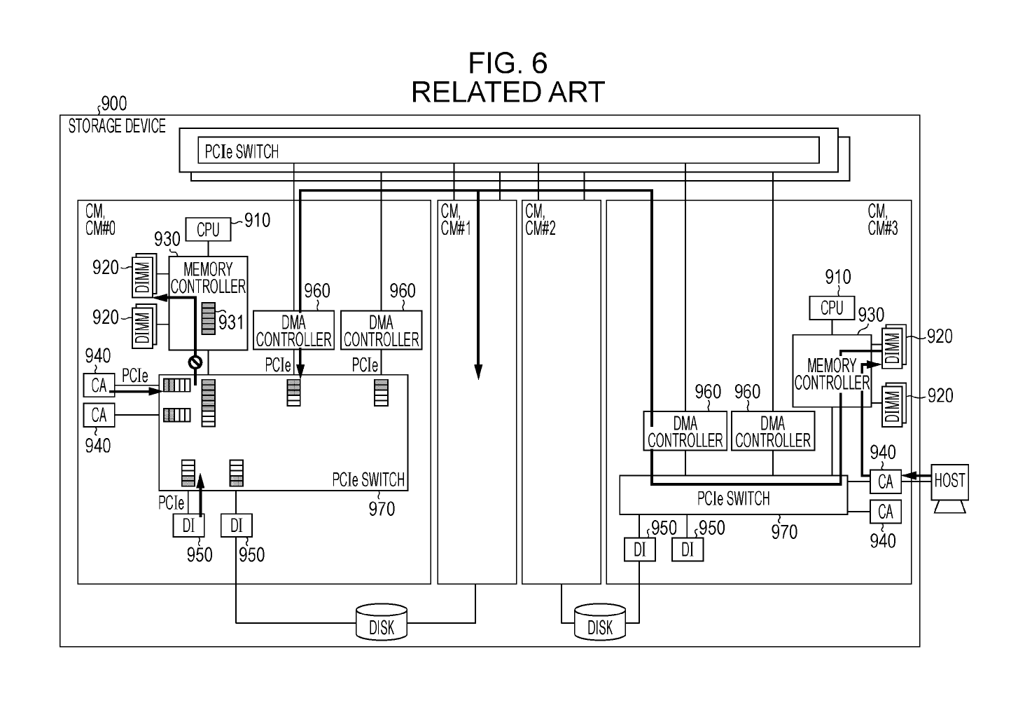

### DESCRIPTION OF EMBODIMENTS

Embodiments of a storage device and a write completion notification method which the present application discloses, are described in detail below, based on the drawings. Moreover, the present disclosure is not limited by the present embodiments. The embodiments may be appropriately combined with each other within the scope that causes no conflict with the processing content.

A case is described below where the present embodiments are applied to the storage device.

### First Embodiment

Configuration of Storage Device

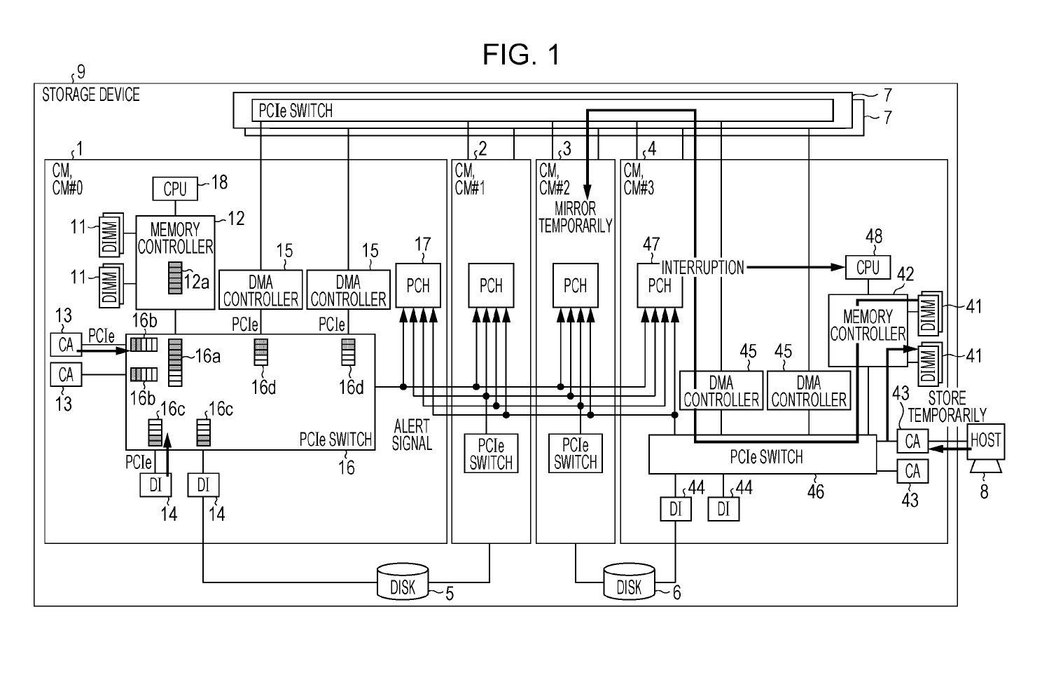

FIG. 1 is a diagram illustrating a hardware configuration of a storage device according to a first embodiment. As illustrated in FIG. 1, a storage device 9 has multiple controller modules (CMs) 1 to 4, disks 5 and 6, and PCIe switches 7. The CMs 1 to 4 are connected to each other via the PCIe switch 7. The CMs 1 and 2 are connected to the disk 5 and make data redundant. The CMs 3 and 4 are connected to the disk 6 and make data redundant. Additionally, the CM 4 is connected to a host 8 that indicates a host computer such as a server. A description is provided below with a focus on an operation in a case where the CM 4 receives a command that writes the data to the disk 5 managed by the CMs 1 and 2, from the host 8. The CM 4 is one example of a “second control device,” and the CMs 1 and 2 are one example of a “first control device.”

The CM 1 has a DIMM 11, a memory controller 12, a CA 13, a DI 14, a DMA controller 15, a PCIe switch 16, a Platform Controller Hub (PCH) 17, and a CPU 18. Since the CM 2 has the same configuration as the CM 1, a description of the configuration of the CM 2 is omitted.

The DIMM 11 is a memory module. The memory controller 12 controls the write of the data to the DIMM 11 using a queue. The memory controller 12 has a queue 12a inside, and receives a packet that is output from the PCIe switch 16 described below, and accumulates the packet in the queue 12a. The memory controller 12 sequentially writes the packets accumulated in the queue 12a to the DIMM 11. When the queue 12a is full, the memory controller 12 is unable to receive the packet from the PCIe switch 16 until there is room in the queue 12a. A case where write commands are intensively issued from the host 8 is an example in which the queue 12a is full.

The CA 13 is an interface with the host 8. The DI 14 is an interface with the disk 5.

The DMA controller 15 is a controller in DMA between the CMs. DMA refers to a data transfer method in which data is transferred directly between the DIMM 11 and another CM without involving the CPU. The write of the data to the DIMM 11 by DMA is herein referred to as “DMA write.” For example, when receiving a DMA write command, as the data write command, from the CM 4, the DMA controller 15 tries the DMA write to the DIMM 11 via the PCIe switch 16. When the DMA write to the DIMM 11 is complete, the DMA controller 15 performs DMA write completion interruption on the CPU 18 described below.

The PCIe switch 16 is a switch that is exemplified by an input/output interface that conforms to PCIe specification. The PCIe switch 16 is connected to the memory controller 12, the CA 13, the DI 14, and the DMA controller 15 as the input/output devices. The PCIe switch 16 has the queue inside for every input/output device, and sequentially processes the packets accumulated in the queue. For example, the PCIe switch 16 has a queue 16a to accumulate the packets to be output to the memory controller 12. Furthermore, the PCIe switch 16 has a queue 16b to accumulate the packets from the CA 13. Furthermore, the PCIe switch 16 has a queue 16c to accumulate the packets from the D1 14. Furthermore, the PCIe switch 16 has a queue 16d to accumulate the packets from the DMA controller 15.

Furthermore, the PCIe switch 16 determines whether or not the queue 12a inside the memory controller 12 is full. In a case where it is determined that the queue 12a inside the memory controller 12 is full, the PCIe switch 16 outputs a signal (for example, referred to as an “alert signal”) indicating that the queue 12a is full, directly to another CM. Thus, the PCIe switch 16 may easily alert the CM 4 performing the DMA write that the queue 12a inside the memory controller 12 is full. The PCIe switch 16 is one example of a “first determination unit” and a “first notification unit.” The PCIe switch 16 may determine whether or not the queue 12a inside the memory controller 12 is full, using the number of capacity credits in the queue 12a inside the memory controller 12.

The PCH 17 is a chip that has a connection interface with an interruption controller and a peripheral device.

The CPU 18 has internal memories for storing a program and control data that define various processing procedures, and executes various processes using these. The CPU 18 detects the interruption and executes the various processes according to the detected interruption. For example, the CPU 18 notifies the CM 4 that the DMA write is complete, when detecting the DMA write completion interruption from the DMA controller 15.

The CM 4 has a DIMM 41, a memory controller 42, a CA 43 and a DI 44, a DMA controller 45, a PCIe switch 46, a PCH 47, and a CPU 48. Since the CM 3 has the same configuration as the CM 4, a description of the configuration of the CM 3 is omitted.

The DIMM 41 is a memory module. The memory controller 42 controls the write of the data to the DIMM 41 using the queue.

The CA 43 is an interface with the host 8. For example, when receiving the command that writes the data to the disk 5 managed by the CMs 1 and 2, from the host 8, the CA 43 performs the DMA write of the data to the DIMM 41 via the memory controller 42. That is, the CA 43 performs the write of the data to the DIMM 41 through DMA. Write of the data by the CA 43 to the DIMM 41 is performed for the purpose of temporarily evacuating data on the write command.

The DI 44 is an interface with the disk 6.

The DMA controller 45 is a controller in DMA between the CMs.

For example, when the data write command is executed on the memory space of the CM 1 and the CM 2, the DMA controller 45 performs the DMA write to the memory spaces of the CM 1 and the CM 2.

The PCIe switch 46 is connected to the memory controller 42, the CA 43, the DI 44, and the DMA controller 45 as the input/output devices. Although not illustrated, the PCIe switch 46 has the queue inside, for every input/output device, and sequentially processes the packets accumulated in the queue.

The PCH 47 is a chip that has a connection interface with an interruption controller and a peripheral device. When the alert signal is input from another CM, the PCH 47 performs the interruption alerting the CPU 48 described below that the alert signal is input from the corresponding CM.

The CPU 48 has internal memories for storing a program and control data that define various processing procedures, and executes various processes using these. The CPU 48 detects the interruption and executes the various processes according to the detected interruption. For example, the CPU 48 determines whether or not the alert signal from the CM 1 or the CM 2 is output as a notification, in a case of receiving the command that writes the data to the CM 1 and the CM 2 from the host 8. Whether or not the alert signal is output as a notification from the CM 1 or the CM 2 is determined depending on whether or not the interruption from the PCH 47 is detected. In a case where it is determined that the alert signal from the CM 1 or the CM 2 is output as a notification, the CPU 48 evacuates the data on the write command to the CM 3 which is made redundant with the CM 4. Although the data is temporarily stored in the DIMM 41 of the CM 4, the CM 4 additionally evacuates the data in preparation for an event of a possible failure of the CM 4. When receiving from the CM 3 a notification that the data evacuation is complete, the CPU 48 notifies the host 8 that the data write is complete, via the CA 43. Thus, even though the alert signal is output as a notification from the CM 1 or the CM 2, the CM 4 may notify the host 8 that the data write is complete, thereby suppressing a decrease in the write performance of the host 8. Moreover, the CPU 48 is one example of a “second determination unit,” an “evacuation unit,” and a “second notification unit.”

Furthermore, when receiving from the CM 3 a notification that the data evacuation is complete, the CPU 48 performs the DMA write to the CM 1 and the CM 2 in a case where it is determined that the alert signal is not output as a notification, from the CM 1 and the CM 2. The DMA write is performed via the DMA controller 45. When receiving a DMA write completion notification from the CM 1 and the CM 2, the CPU 48 discards the evacuated data. That is, the CPU 48 discards the data stored in the DIMM 41 of the CM 4, and the data evacuated to the CM 3.

The operation of the CM 4 is described above in a case where the alert signal from the CM 1 or CM 2 is input when the command that writes the data to the CM 1 and the CM 2 is received from the host 8. However, in the CM 4, there is also a case where the alert signals from the CM 1 and the CM 2 are not input. In such a case, in the CM 4, the CPU 48 performs the DMA write to the CM 1 and CM 2 without evacuating the data. In the CM 4, when receiving the DMA write completion notification from the CM 1 and the CM 2, the CPU 48 notifies the host 8 that the data write is complete, via the CA 43. In such a case, the CM4 may immediately notify the host 8 that the data write is complete, thereby maintaining the write performance of the host 8.

Sequence between CMs of Storage Device

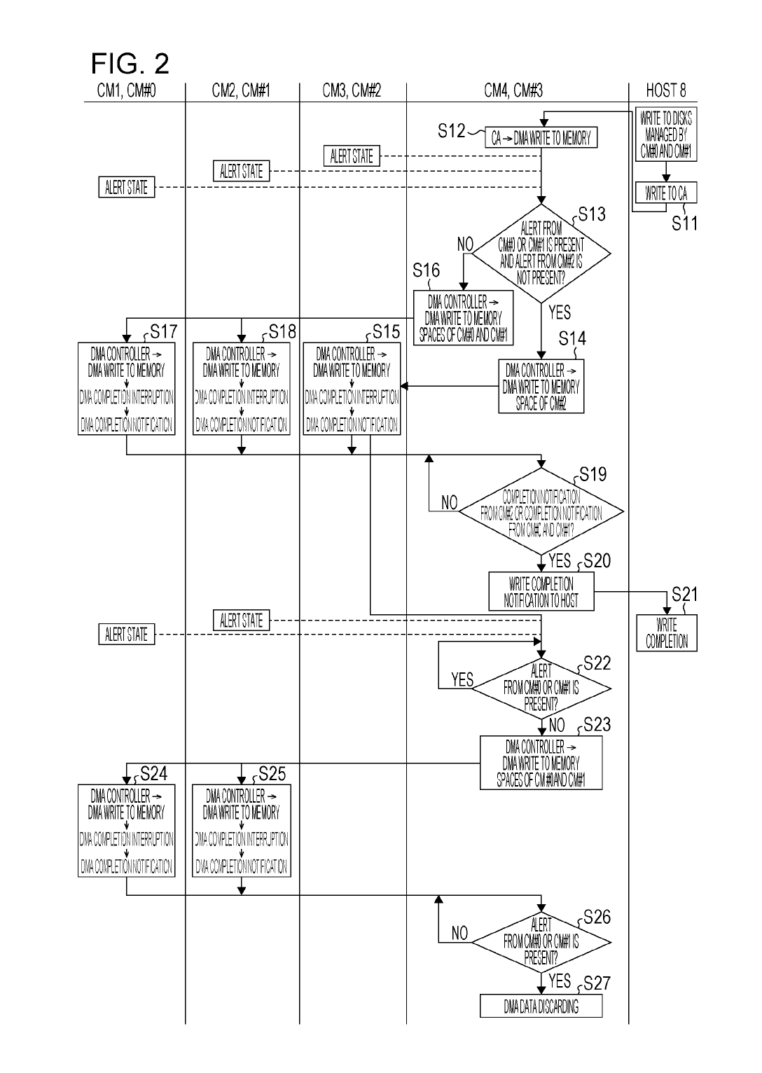

Next, a sequence between the CMs of the storage device according to the first embodiment is described referring to FIG. 2. FIG. 2 is a diagram illustrating the sequence between the CMs of the storage device according to the first embodiment. Note that, in FIG. 2, a CM 1 is described as a CM #0, a CM 2 as a CM #1, a CM 3 as a CM #2, and a CM 4 as a CM #3. Moreover, the host 8 is connected to the CM #3. Furthermore, the alert described in FIG. 2, for example, refers to the alert signal.

First, the host 8 executes a write command on the CA 43 of the CM #3, in order to perform the write of data to a disk 5 managed by the CM #0 and the CM #1 (Operation S11). In the CM #3, the CA 43 receiving the write command performs the DMA write of the data to the DIMM 41 via the memory controller 42 (Operation S12). That is, the DIMM 41 temporarily stores the data.

Subsequently, the CPU 48 of the CM #3 determines whether or not the alert from the CM #0 or the CM #1 is present and furthermore, the alert from the CM #2 which is made redundant with the CM #3 is present (Operation S13). For example, whether or not the alert from a CM is present is determined depending on whether or not the interruption from the PCH 47 is detected. In a case where it is determined that the alert from the CM #0 or the CM #1 is present and additionally the alert from the CM #2 is not present (Operation S13: Yes), the DMA controller 45 performs the DMA write of the data to the memory space of the CM #2 (Operation S14). In other words, the DMA controller 45 evacuates the data on the write command to the CM #2 which is made redundant with the CM #3.

Then, in the CM #2, the DMA controller performs the DMA write of the data to the DIMM. Further, when the DMA write to the DIMM is complete, the DMA controller performs the DMA write completion interruption on the CPU. Furthermore, the CPU that detects the DMA write completion interruption notifies the CM #3 that the DMA write is complete (Operation S15) and proceeds to Operation S19 and Operation S22.

On the other hand, in a case where it is determined that none of the alerts from the CM #0 and the CM #1 is present (Operation S13; No), the DMA controller 45 performs the DMA write of the data to the memory space of each of the CM #0 and the CM #1 (Operation S16). In other words, the DMA controller 45 performs the DMA write to the CM #0 and the CM #1 without evacuating the data.

In the CM #0, the DMA controller 15 performs the DMA write of the data to the DIMM 11. When the DMA write to the DIMM 11 is complete, the DMA controller 15 performs the DMA write completion interruption on the CPU 18. Furthermore, the CPU 18 that detects the DMA write completion interruption notifies the CM #3 that the DMA write is complete (Operation S17) and proceeds to Operation S19.

In the CM #1, the DMA controller performs the DMA write of the data to the DIMM. When the DMA write to the DIMM is complete, the DMA controller performs the DMA write completion interruption on the CPU. Furthermore, the CPU that detects the DMA write completion interruption notifies the CM #3 that the DMA write is complete (Operation S18) and proceeds to Operation S19.

In Operation S19, the CPU 48 of the CM #3 determines whether or not the DMA write completion notification from the CM #2, or the DMA write completion notifications from the CM #0 and the CM #1 are present (Operation S19). In a case where it is determined that the DMA write completion notification from the CM #2 is not present and the DMA write completion notifications from the CM #0 and the CM #1 are not present (Operation S19: No), the CPU 48 repeats determination processing. On the other hand, in a case where it is determined that the DMA write completion notification from the CM #2, or the DMA write completion notifications from the CM #0 and the CM #1 are present (Operation S19: Yes), the CPU 48 notifies the host 8 that the data write is complete, via the CA 43 (Operation S20). The host 8, which is notified that the data write is complete, detects the write completion (Operation S21).

In Operation S22, the CPU 48 of the CM #3 determines whether or not the alert from the CM #0 or the CM #1 is present (Operation S22). In a case where it is determined that the alert from the CM #0 or the CM #1 is present (Operation S22: Yes), the CPU 48 repeats the determination processing. On the other hand, in a case where it is determined that none of the alerts from the CM #0 and the CM #1 is present (Operation S22: No), the DMA controller 45 performs the DMA write of the data to the memory space of each of the CM #0 and the CM #1 (Operation S23). In other words, since none of the alerts from the CM #0 and the CM #1 is present, the DMA controller 45 performs the DMA write to the CM #0 and the CM #1.

In the CM #0, the DMA controller 15 performs the DMA write of the data to the DIMM 11. When the DMA write to the DIMM 11 is complete, the DMA controller 15 performs the DMA write completion interruption on the CPU 18. Furthermore, the CPU 18 that detects the DMA write completion interruption notifies the CM #3 that the DMA write is complete (Operation S24) and proceeds to Operation S26.

In the CM #1, the DMA controller performs the DMA write of the data to the DIMM. When the DMA write to the DIMM is complete, the DMA controller performs the DMA write completion interruption on the CPU. Furthermore, the CPU that detects the DMA write completion interruption notifies the CM #3 that the DMA write is complete (Operation S25) and proceeds to Operation S26.

In Operation S26, the CPU 48 of the CM #3 determines whether or not the DMA write completion notifications from the CM #0 and the CM #1 are present (Operation S26). In a case where it is determined that the DMA write completion notification from one of the CM #0 and the CM #1 is not present (Operation S26: No), the CPU 48 repeats the determination processing.

On the other hand, in a case where it is determined that the DMA write completion notifications from the CM #0 and the CM #1 are present (Operation S26; Yes), the CPU 48 discards the temporarily-stored data (Operation S27). For example, the CPU 48 discards the data temporarily stored in the DIMM 41 of the CM #3, and the data evacuated to the CM #2.

Effects of First Embodiment

According to the first embodiment described above, in the CM 1, the memory controller 12 controls the write of the data to the DIMM 11 using the queue 12a. The PCIe switch 16 determines whether or not the queue 12a inside the memory controller 12 is full, and notifies the CM 4 that the queue 12a is full, in a case where it is determined that the queue 12a inside the memory controller 12 is full. In the CM 4, in a case of receiving the command that writes the data to the disk 5 managed by the CM 1 from the host 8, the CPU 48 determines whether or not the CM 1 notifies the CM 4 that the queue 12a is full. In a case where it is determined that the CM 1 notifies the CM 4 that the queue 12a is full, the CPU 48 evacuates the data on the write command to another CM. Additionally, after the evacuation is complete, the CPU 48 notifies the host 8 that the write is complete, via the CA 43. According to this configuration, the CM 4 may reduce the decrease in the write performance of the host 8, since the CM 4 notifies the host 8 that the data write is complete, after evacuating the data, even if the CM 4 receives the command that writes the data to the CM 1 in which the queue 12a is full, from the host 8.

Furthermore, according to the first embodiment, the PCIe switch 16 of the CM 1 outputs the notification (the alert signal) that the queue 12a inside the memory controller 12 is full, directly to the CM 4. In the CM 4, the CPU 48 determines whether or not the CM 1 notifies the CM 4 that the queue 12a is full. According to this configuration, the CM 4 may easily be aware that the queue 12a inside the memory controller 12 of the CM 1 has no space.

According to the first embodiment, when receiving the notification that the data write is complete, from the CM 1, the CPU 48 of the CM 4 discards the evacuated data. According to this configuration, since the CPU 48 discards the data evacuated beforehand when the write of the data to the CM 1 is complete, subsequently, the CPU 48 may increase the efficiency in the use of the memory.

### Second Embodiment

In the storage device 9 according to the first embodiment, the case is described where the PCIe switch 16 outputs the notification that the queue 12a inside the memory controller 12 is full, directly to another CM. However, the storage device 9 is not limited thereto, and in cooperation with the PCIe switch 16, the CPU 18 may output the notification that the queue 12a inside the memory controller 12 is full, to the other CM. Accordingly, in a second embodiment, a storage device 9A is described in which in cooperation with the PCIe switch 16, the CPU 18 outputs the notification that the queue 12a inside the memory controller 12 is full, to the other CM.

Configuration of Storage Device according to Second Embodiment

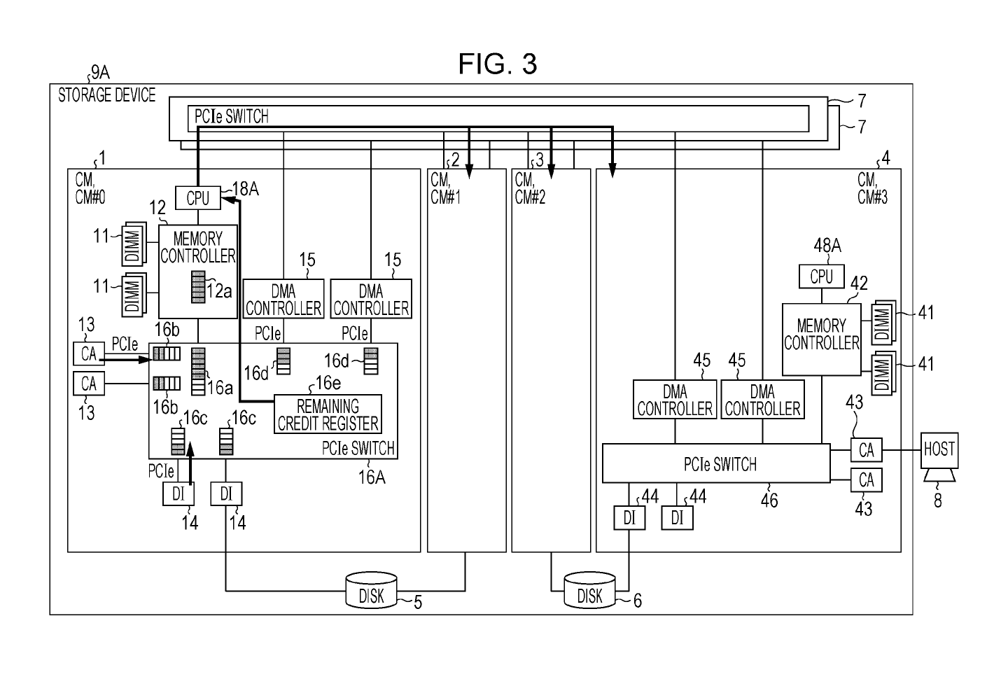

FIG. 3 is a diagram illustrating a hardware configuration of the storage device according to the second embodiment. The same reference numerals are given to the same configuration as that of the storage device 9 illustrated in FIG. 1, and descriptions of the overlapping configuration and operation are omitted. Difference between the first embodiment and the second embodiment is that the PCIe switch 16 in the first embodiment is changed to a PCIe switch 16A in the second embodiment. Furthermore, the CPU 18 in the first embodiment is changed to a CPU 18A in the second embodiment. Moreover, the CPU 48 in the first embodiment is changed to a CPU 48A in the second embodiment.

The PCIe switch 16A has a remaining credit register 16e. The remaining credit register 16e is a register that holds the number of remaining (capacity) credits in the queue 12a inside the memory controller 12. The PCIe switch 16A determines whether or not the queue 12a inside the memory controller 12 is full using the remaining credit register 16e, and if the PCIe switch 16A determines that the queue 12a is full, notifies the CPU 18A described below that the queue 12a is full, with alert. As one example, the PCIe switch 16A performs the interruption indicating that the queue 12a is full, on the CPU 18A. As another example, in response to an inquiry (for example, polling) from the CPU 18A, the PCIe switch 16A notifies the CPU 18A that the queue 12a is full, when the queue 12a is full.

When detecting the alert indicating that the queue 12a inside the memory controller 12 is full, the CPU 18A notifies the CM 4 connecting to the host 8 of the detected alert, via the PCIe switches 7. As one example, when detecting the interruption indicating that the queue 12a is full, from the PCIe switch 16A, the CPU 18A notifies the CM 4 that the queue 12a is full, with alert. As another example, the CPU 18A periodically asks the PCIe switch 16A whether or not the queue 12a inside the memory controller 12 is full. When the CPU 18A detects the alert, in response to the inquiry, from the PCIe switch 16A indicating that the queue 12a is full, the CPU 18A notifies the CM 4 of the detected alert. The CPU 18A is one example of the “first notification unit.”

In a case of receiving the command that writes the data to the CM 1 and the CM 2 from the host 8, the CPU 48A determines whether or not the CM 1 or the CM 2 notifies the CM 4 that the queue is full, with alert. Whether or not the CM 1 or the CM 2 notifies the CM 4 that the queue is full with alert is determined depending on whether or not a message transmission is received via the PCIe switches 7. The CPU 48A evacuates the data on the write command to the CM 3 which is made redundant with the CM 4, when determining that the alert from the CM 1 or the CM 2 is provided as a notification. When receiving from the CM 3 a notification that the data evacuation is complete, the CPU 48A notifies the host 8 that the data write is complete, via the CA 43. Thus, even though the alert is provided as a notification from the CM 1 or the CM 2, the CM 4 may notify the host 8 that the data write is complete, thereby suppressing a decrease in the write performance of the host 8.

Furthermore, when receiving from the CM 3 a notification that the data evacuation is complete, the CPU 48A performs the DMA write to the CM 1 and the CM 2 in a case where it is determined that the alert is not provided as a notification, from the CM 1 and the CM 2. The DMA write is performed via the DMA controller 45. When receiving the DMA write completion notifications from the CM 1 and the CM 2, the CPU 48A discards the evacuated data. That is, the CPU 48A discards the data stored in the DIMM 41 of the CM 4 and the data evacuated to the CM #2. The CPU 48A is one example of a “discard unit.”

Sequence between CMs of Storage Device

A sequence between the CMs of the storage device according to the second embodiment is similar to the sequence in the first embodiment, and thus a description of the sequence is omitted.

Effects of Second Embodiment

According to the second embodiment, in the CM 1, the CPU 18A receives from the PCIe switch 16A a notification (the alert) that the queue 12a inside the memory controller 12 is full and provides the CM 4 with the notification via the PCIe switches 7. In the CM 4, the CPU 48A determines whether or not the CM 1 notifies the CM 4 that the queue 12a is full. According to this configuration, the CM 4 may easily be notified from the CM 1 that the queue 12a inside the memory controller 12 has no space, without adding a the new device. As a result, even though the write command from the post 8 is concentrated at the same CM 1, the decrease in the write performance of the post 8 may be controlled.

Furthermore, according to the second embodiment, in the CM 1, the CPU 18A detects the notification (the alert) that the queue 12a inside the memory controller 12 is full, by asking the PCIe switch 16A. The CPU 18A notifies the CM 4 of the detected alert via the PCIe switch 7. According to this configuration, the CM 4 may also easily be aware that the queue 12a inside the memory controller 12 of the CM 1 has no space, without adding a the new device. As a result, even in the case where the write commands from the post 8 are concentrated at the same CM 1, the decrease in the write performance of the post 8 may be reduced.

### Third Embodiment

In the storage device 9 according to the first embodiment, the case is described where the CPU 48 of the CM 4 evacuates the data on the write command to the CM 3 in which the disk is made redundant, when the CM 1 notifies the CM 4 that the queue 12a inside the memory controller 12 is full. However, in the storage device 9, the CPU 48 may evacuate the data on the write command to a CM that is made redundant again at the time when the CM 3, in which the disk has been made redundant, is in a fall back state, in a case where the CM 1 notifies the CM 4 that the queue 12a inside the memory controller 12 is full. Thus, in the third embodiment, a storage device 9B is described in which a CPU 48B evacuates the data on the write command to a CM which is made redundant again at the time when the CM 3, in which the disk has been made redundant, is in a fall back state.

Configuration of Storage Device according to Third Embodiment

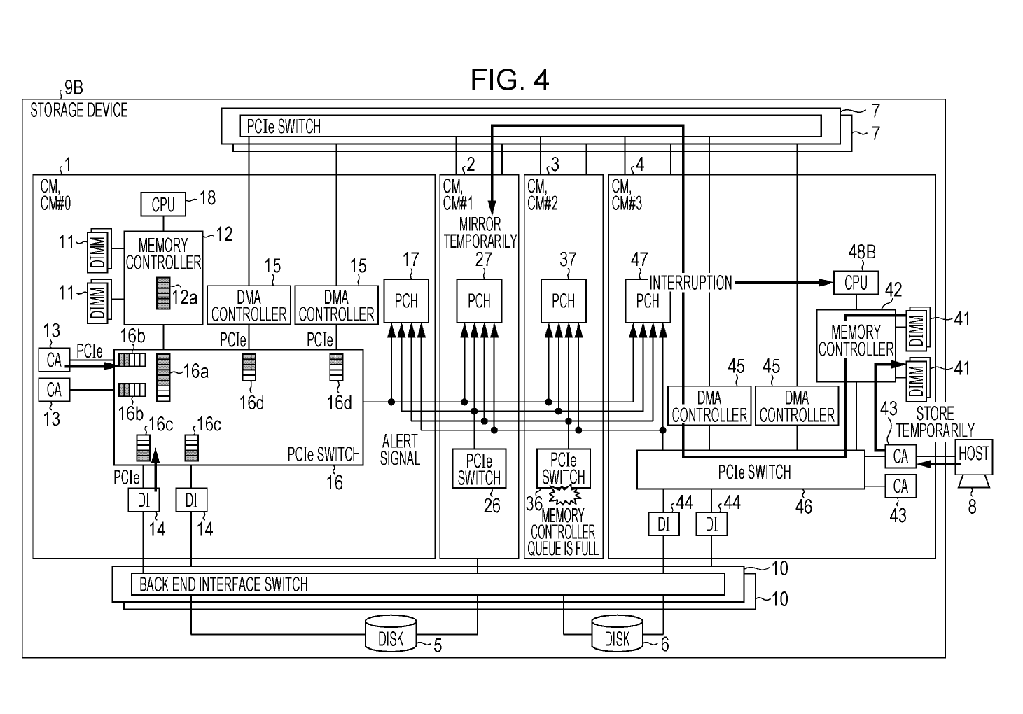

FIG. 4 is a diagram illustrating a hardware configuration of the storage device according to the third embodiment. The same reference numerals are given to the same configuration as that of the storage device 9 illustrated in FIG. 1, and descriptions of the overlapping configuration and operations are omitted. Difference between the third embodiment and the first embodiment is that a back end interface switch 10 is added to the storage device 9B in the third embodiment. Furthermore, the CPU 48 in the first embodiment is changed to the CPU 48B in the third embodiment.

The back end interface switch 10 is a switch that performs switching in management of making the disk redundant. For example, in a case where the CM 3 and the CM 4 are connected to the disk 6 and the data is made redundant, at the time when the CM 3 is in a fall back state, the back end interface switch 10 switches the CM 3 to a different CM and makes the different CM and CM 4 redundant again.

In a case of receiving the command that writes the data to the CM 1 and the CM 2 from the host 8, the CPU 48B determines whether or not the alert signal has been output from the CM 1 or the CM 2 as a notification. Whether or not the alert signal has been output as a notification from another CM is determined depending on whether or not the interruption from the PCH 47 is detected. In a case where it is determined that the alert signal has been output from the CM 1 or the CM 2, the CPU 48B further determines whether or not the alert signal has been output from the CM 3 which is made redundant with the CM 4. In a case where it is determined that the alert signal has been output from the CM 3 which is made redundant with the CM 4, the CPU 48B makes a CM which has not output the alert signal as a notification, redundant with the CM 4, using the back end interface switch 10. When the CM that is a data write command destination is included in CMs from which the alert signal is not output, the CPU 48B may make the CM and the CM 4 redundant again. This is because the data may be written also to that CM at the time point when the alert signal from the CM that is the data write command destination is not output as a notification.

Sequence between CMs of Storage Device

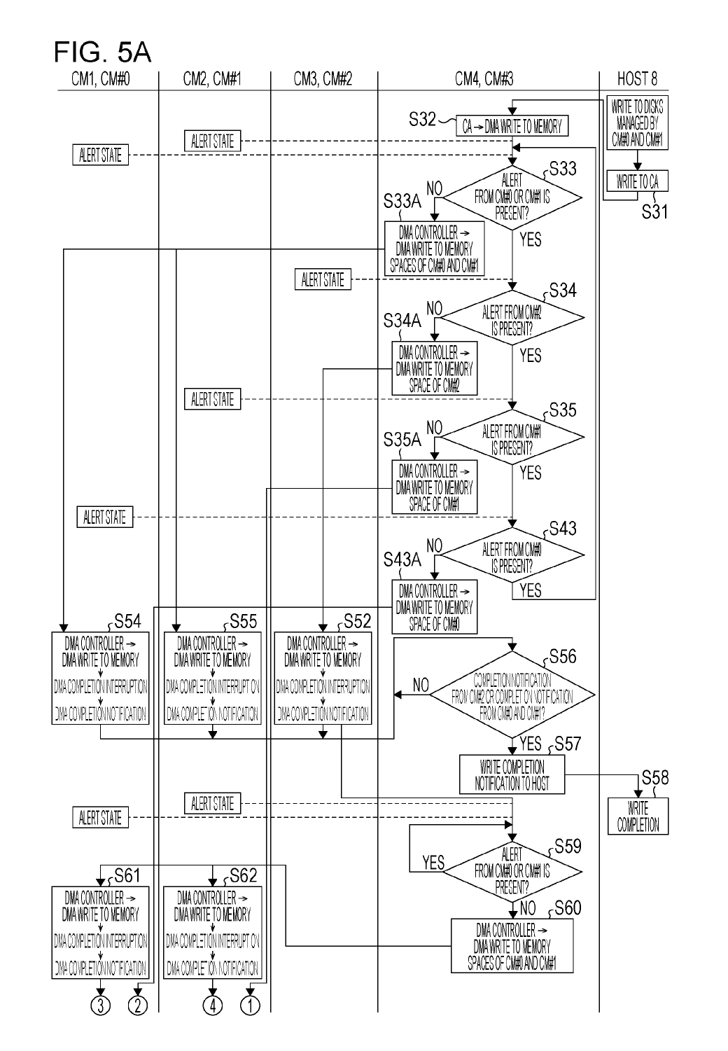

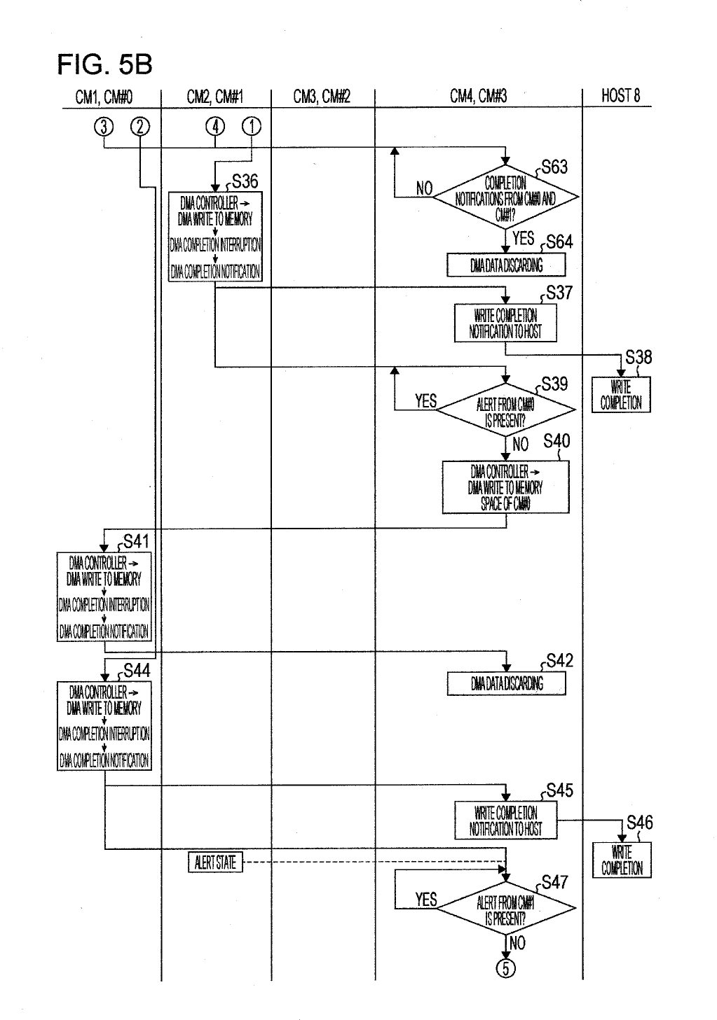

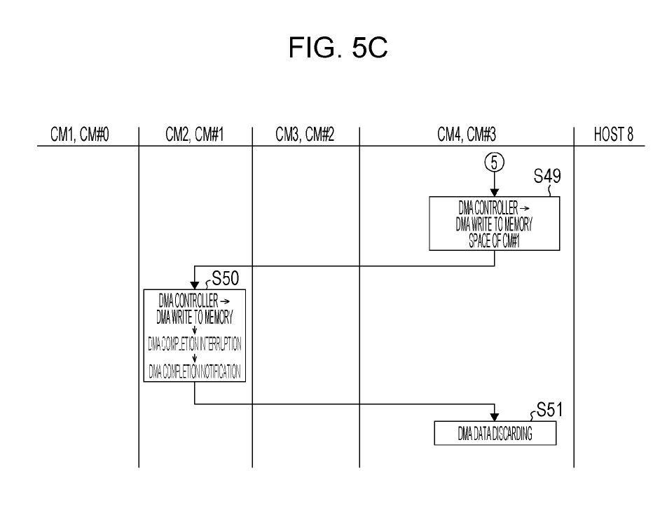

The sequence between the CMs of the storage device according to the third embodiment is described referring to FIGS. 5A to 5C. FIGS. 5A to 5C are diagrams illustrating the sequence between the CMs of the storage device according to the third embodiment. In FIGS. 5A to 5C, the CM 1 is described as the CM #0, the CM 2 as the CM #1, the CM 3 as the CM #2, and the CM 4 as the CM #3. Moreover, the host 8 is connected to the CM #3. Furthermore, the alert illustrated in FIGS. 5A and 5C, for example, refers to an alert signal.

First, the host 8 executes the write command on the CA 43 of the CM #3, in order to perform the write of the data to the disk 5 managed by the CM #0 and the CM #1 (Operation S31). In the CM #3, the CA 43 receiving the write command performs the DMA write of the data to the DIMM 41 via the memory controller 42 (Operation S32). That is, the DIMM 41 temporarily stores the data.

Subsequently, the CPU 48B of the CM #3 determines whether or not the alert from the CM #0 or the CM #1 is present (Operation S33). For example, whether or not the alert from a CM is present is determined depending on whether or not the interruption from the PCH 47 is detected. In a case where it is determined that the alert from the CM #0 or the CM #1 is present (Operation S33; Yes), the CPU 48B further determines whether or not the alert from the CM #2 that is made redundant with the CM #3 is present (Operation S34).

In a case where it is determined that the alert from the CM #2 that is made redundant with the CM #3 is present (Operation S34; Yes), the CPU 48B of the CM #3 further determines whether or not the alert from the CM #1, one of the write command destinations, is present (Operation S35). At this point, in a case where it is determined that the alert from the CM #1, one of the write command destinations, is not present (Operation S35; No), the DMA controller 45 performs the DMA write of the data to the memory space of the CM #1 (Operation S35A). In other words, since the alert from the CM #2 which is made redundant with the CM #3 is present and the data on the write command is unable to be evacuated to the CM #2, the DMA controller 45 evacuates the data to the CM #1 which is one of the write command destinations and from which the alert has not been output.

Subsequently, in the CM #1, the DMA controller performs the DMA write of the data to the DIMM. When the DMA write to the DIMM is complete, the DMA controller performs the DMA write completion interruption on the CPU. Furthermore, the CPU that detects the DMA write completion interruption notifies the CM #3 that the DMA write is complete (Operation S36) and proceeds to Operation S37 and Operation S39.

In Operation S37, the CPU 48B of the CM #3 notifies the host 8 that the data write is complete, via the CA 43 (Operation S37) The host 8, which is notified that the data write is complete, detects the write completion (Operation S38)

In Operation S39, the CPU 48B of the CM #3 determines whether or not the alert from the CM #0 is present (Operation S39). In a case where it is determined that the alert from the CM #0 is present (Operation S39; Yes), the CPU 48B repeats the determination processing. On the other hand, in a case where it is determined that the alert from the CM #0 is not present (Operation S39; No), the DMA controller 45 performs the DMA write of the data to the memory space of the CM #0 (Operation S40). In other words, since the alert from the CM #0 is not present, the DMA controller 45 performs the DMA write to the CM #0.

In the CM #0, the DMA controller 15 performs the DMA write of the data to the DIMM 11. When the DMA write to the DIMM 11 is complete, the DMA controller 15 performs the DMA write completion interruption on the CPU 18.

Furthermore, the CPU 18 that detects the DMA write completion interruption notifies the CM #3 that the DMA write is complete (Operation S41).

In the CM #3, the CPU 48B that receives the DMA write completion notification from the CM #0 discards the temporarily stored data (Operation S42). At this point, the CPU 48B uses the data evacuated to the CM #1 as it is, and discards the data temporarily stored in the DIMM 41 of the CM #3.

In Operation S35, in a case where it is determined that the alert from the CM #1, one of the write command destinations, is present (Operation S35; Yes), the CPU 48B of the CM #3 determines whether or not the alert from the CM #0, the other of the write command destinations, is present (Operation S43). At this point, in a case where it is determined that the alert from the CM #0, the other of the write command destinations, is present (Operation S43; Yes), the CPU 48B proceeds to Operation 33 in order to repeat the determination processing. This is because the alert from either of the CM #0 and the CM #1, which are the write command destinations, is present.

On the other hand, in a case where it is determined that the alert from the CM #0, the other of the write command destinations, is not present (Operation S43; No), the DMA controller 45 performs the DMA write of the data to the memory space of the CM #0 (Operation S43A). In other words, since the alert from the CM #2 which is made redundant with the CM #3 is present and the data on the write command is unable to be evacuated to the CM #2, the DMA controller 45 evacuates the data to the CM #0 which is one of the write command destinations and from which the alert has not been output.

In the CM #0, the DMA controller 15 performs the DMA write of the data to the DIMM 11. When the DMA write to the DIMM 11 is complete, the DMA controller 15 performs the DMA write completion interruption on the CPU 18. Furthermore, the CPU 18 that detects the DMA write completion interruption notifies the CM #3 that the DMA write is complete (Operation S44) and proceeds to Operation S45 and Operation S47.

In Operation S45, the CPU 48B of the CM #3 notifies the host 8 that the data write is complete, via the CA 43 (Operation S45). The host 8, which is notified that the data write is complete, detects the write completion (Operation S46)

In Operation S47, the CPU 48B of the CM #3 determines whether or not the alert from the CM #1 is present (Operation S47). In a case where it is determined that the alert from the CM #1 is present (Operation S47; Yes), the CPU 48B repeats the determination processing. On the other hand, in a case where it is determined that the alert from the CM #1 is not present (Operation S47; No), the DMA controller 45 performs the DMA write of the data to the memory space of the CM #1 (Operation S49). In other words, since the alert from the CM #1 is not present, the DMA controller 45 performs the DMA write to the CM #1.

In the CM #1, the DMA controller performs the DMA write of the data to the DIMM. When the DMA write to the DIMM is complete, the DMA controller performs the DMA write completion interruption on the CPU. Furthermore, the CPU 18 that detects the DMA write completion interruption notifies the CM #3 that the DMA write is complete (Operation S50).

In the CM #3, the CPU 48B that receives the DMA write completion notification from the CM #1 discards the temporarily stored data (Operation S51). At this point, the CPU 48B uses the data evacuated to the CM #0 as it is, and discards the data temporarily stored in the DIMM 41 of the CM #3.

The processing in the case where the alerts from the CM #0 and the CM #1 are not present (Operation S33; No) and the processing in the case where the alert from the CM #0 or the CM #1 is present and additionally the alert from the CM #2 is not present (Operation S34; No) are described referring to Operations S 14 to S27 in FIG. 2. Therefore, such processing is briefly described below.

In operation S34, in a case where the alert from the CM #0 or the CM #1 is present and additionally the alert from the CM #2 is not present (Operation S34; No), the DMA controller 45 performs the DMA write of the data to the memory space of the CM #2 (Operation 534A). The DMA controller 45 evacuates the data on the write command to the CM #2 which is made redundant with the CM #3.

In the CM #2, the DMA controller performs the DMA write of the data to the DIMM, and performs the DMA write completion interruption on the CPU. Furthermore, the CPU notifies the CM #3 that the DMA write is complete (Operation S52) and proceeds to Operation S56 and Operation S59.

In Operation S33, in a case where it is determined that none of the alerts from the CM #0 and the CM #1 is present (Operation S33: No), the DMA controller 45 performs the DMA write of the data to the memory space of each of the CM #0 and the CM #1 (Operation S33A). The DMA controller 45 performs the DMA write to the CM #0 and the CM #1, as they are, without evacuating the data.

In the CM #0, the DMA controller 15 performs the DMA write of the data to the DIMM 11, and performs the DMA write completion interruption on the CPU 18. Furthermore, the CPU 18 notifies the CM #3 that the DMA write is complete (Operation S54) and proceeds to Operation S56. In the CM #1, the DMA controller performs the DMA write of the data to the DIMM, and performs the DMA write completion interruption on the CPU. Furthermore, the CPU notifies the CM #3 that the DMA write is complete (Operation S55) and proceeds to Operation S56.

In Operation S56, the CPU 48B of the CM #3 determines whether or not the DMA write completion notification from the CM #2, or the DMA write completion notifications from the CM #0 and the CM #1 are present (Operation S56). In a case where it is determined that the DMA write completion notification from the CM #2, or the DMA write completion notifications from the CM #0 and the CM #1 are present (Operation S56: Yes), the CPU 48 B notifies the host 8 that the data write is complete (Operation S57). The host 8, which is notified that the data write is complete, detects the write completion (Operation S58).

In Operation S59, the CPU 48 of the CM #3 determines whether or not the alert from the CM #0 or the CM #1 is present (Operation S59). In a case where it is determined that the alert from the CM #0 or the CM #1 is present (Operation S59; Yes), the CPU 48 B repeats the determination processing. On the other hand, in a case where it is determined that none of the alerts from the CM #0 and the CM #1 is present (Operation S59: No), the DMA controller 45 performs the DMA write of the data to the memory space of each of the CM #0 and the CM #1 (Operation S60). Since none of the alerts from the CM #0 and the CM #1 is present, the DMA controller 45 performs the DMA write to the CM #0 and the CM #1.

In the CM #0, the DMA controller 15 performs the DMA write of the data to the DIMM 11, and performs the DMA write completion interruption on the CPU 18. Furthermore, the CPU 18 notifies the CM #3 that the DMA write is complete (Operation S61) and proceeds to Operation S63. In the CM #1, the DMA controller performs the DMA write of the data to the DIMM, and performs the DMA write completion interruption on the CPU. Furthermore, the CPU notifies the CM #3 that the DMA write is complete (Operation S62) and proceeds to Operation S63.

In Operation S63, the CPU 48B of the CM #3 determines whether or not the DMA write completion notifications from the CM #0 and the CM #1 are present (Operation S63). In a case where it is determined that the DMA write completion notification from one of the CM #0 and the CM #1 is not present (Operation S63: No), the CPU 48B repeats the determination processing.

On the other hand, in a case where it is determined that the DMA write completion notifications from the CM #0 and the CM #1 are present (Operation S63; Yes), the CPU 48B discards the temporarily-stored data (Operation S64). At this point, the CPU 48B discards the data temporarily stored in the DIMM 41 of the CM #3, and the data evacuated to the CM #2.

Effects of Third Embodiment

According to the third embodiment described above, in the CM 4, in a case of receiving the command that writes the data to the disk managed by the CM 1 and the CM 2, the CPU 48B determines whether or not the CM 1 or the CM 2 notifies the CM 4 that the queue inside the memory controller is full. In a case where it is determined that the CM 1 or the CM 2 notifies the CM 4 that the queue is full, the CPU 48B further determines whether or not the CM 3 which is made redundant with the CM 4 notifies the CM 4 that the queue inside the memory controller is full. In a case where it is determined that the CM 3 notifies the CM 4 that the queue is full, the CPU 48B evacuates the data on the write command to a CM that is different from the CM 3 made redundant with the CM 4 and that does not notify the CM 4 that the queue is full. According to this configuration, even though the CM 3 which is made redundant with the CM 4 notifies the CM 4 that the queue is full, the CM 4 may evacuate the data on the write command to another CM that does not notify the CM 4 that the queue is full. As a result, the CM 4 may evacuate the data in preparation for a possible failure of the CM 4, thereby certainly keeping a loss of the data from occurring.

Furthermore, according to the third embodiment described above, in the CM 4, in a case where it is determined that the CM 3 which is made redundant with the CM 4 notifies the CM 4 that the queue is full, the CPU 48B evacuates the data to the CM 2 which is made redundant with the CM 1 that is the data write command destination. According to this configuration, the CM 4 may accomplish the purpose of evacuating the data using the CM 2 made redundant with the CM 1, and may early perform the writing of the data which has to be made redundant, on the CM 2 which is made redundant with CM 1.

### OTHER EXAMPLES

In the first and third embodiments, the PCH 47 may receive the alert signal from another CM. However, the device that receives the alert signal is not limited to the PCH 47, and may be a connection device between the CMs, which is able to receive the alert signal from another CM.

Furthermore, the storage devices 9, 9A, and 9B are each described on the assumption that the four CMs are made redundant by two CMs at a time.

However, the storage devices 9, 9A, and 9B are not limited thereto. Six CMs may be made redundant by two or more at a time, eight CMs may be made redundant by two or more at a time, and the 10 CMs may be made redundant by two or more at a time.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage device comprising:
a first control device including
a memory controller that controls data write,
a first determination unit that determines a state of a queue managed by the memory controller, and
a first notification unit that outputs a state notification indicating that the queue is in a certain state, in a case where the first determination unit determines that the queue inside the memory controller is in the certain state; and
a second control device including
a second determination unit that determines whether or not the state notification output from the first control device has already been received, in a case where a write command that writes data to a storage medium managed by the first control device is received from a high-level device,
an evacuation unit that evacuates data on the write command to another control device, in a case where the second determination unit determines that the state notification output from the first control device has already been received, and
a second notification unit that outputs to the high-level device a completion notification indicating that writing the data is complete, after the evacuation unit finishes evacuating the data on the write command.

2. The storage device according to claim 1,
wherein the first notification unit outputs the state notification directly to the second control device, and
wherein the second determination unit determines whether or not the state notification output from the first notification unit has already been received.

3. The storage device according to claim 1,
wherein the first notification unit receives the state notification from the first determination unit and outputs the state notification to the second control device via an input/output interface, and
wherein the second determination unit determines whether or not the state notification output from the first notification unit has already been received.

4. The storage device according to claim 1,
wherein the first notification unit detects the state notification by asking the first determination unit, and outputs the detected state notification to the second control device via an input/out interface, and
wherein the second determination unit determines whether or not the state notification output from the first notification unit has already been received.

5. The storage device according to claim 1,
wherein the second determination unit further determines whether or not the state notification output from another control device which is made redundant with the second control device has already been received, and
wherein the evacuation unit evacuates the data on the write command to further another control device that is different from the other control device which is made redundant with the second control device and that does not receive the state notification, in a case where the second determination unit determines that the state notification output from the first control device has already been received, and the state notification output from the other control device which is made redundant with the second control device has already been received.

6. The storage device according to claim 5,
wherein the evacuation unit evacuates the data on the write command to a control device made redundant with the first control device.

7. The storage device according to claims 1, further comprising:
a destruction unit that discards the data evacuated by the evacuation unit, when a notification indicating that writing the data is complete is received from the first control device.

8. A method for write completion notification for use in a storage device including a first control device and a second control device, the method comprising:
causing the first control device to
determine a state of a queue managed by a memory controller controlling data write, and
output a state notification indicating that the queue is in a certain state to the second control unit, in a case where, in the determining, the queue inside the memory controller is in the certain state; and
causing the second control device to
determine whether or not the state notification output from the first control device has already been received, in a case where a write command that writes data to a storage medium managed by the first control device is received from a high-level device,
evacuate data on the write command to another control device, in a case where, in the determining, the state notification output from the first control device has already been received, and
output to the high-level device a completion notification indicating that writing the write is complete, after the evacuation completes in the evacuating the data on the write command.
